(19) United States
(12) Patent Application Publication
(10) Pub. No.: US 2001/0034172 A1
(43) Pub. Date: Oct. 25, 2001

(54) Material reflecting sunlight useful in agriculture and method for obtaining same

(76) Inventors: Jean-Paul Ducol, Tarare (FR); Jean-Pierre Robin, Montpellier (FR); Francois X. Sauvage, Saint Gely Du Fesc (FR)

Correspondence Address: HESLIN ROTHENBERG FARLEY & MESITI PC, 5 COLUMBIA CIRCLE, ALBANY, NY, 12203, US

(21) Appl. No.: 09/859,763

(22) Filed: May 17, 2001

Related U.S. Application Data
(63) Continuation of application No. PCT/FR99/02828, filed on Nov. 18, 1999.

(30) Foreign Application Priority Data
Nov. 19, 1998 (FR) FR 98.14740

(51) Int. Cl. B32B 3/00; B32B 27/14

(52) U.S. Cl. 442/304; 428/195; 428/297.4; 428/304.4

(57) ABSTRACT

The invention concerns a material used in agriculture for increasing the amount of solar radiation received by plants of for modifying its quality, said covering consisting of a planar structure, with greater length than width, comprising reflecting blades (1), juxtaposed in the longitudinal direction of the width and maintained together by a yarn system (2). The system (2) consists of knitted fabric, produced on a knitting machine with overlapping stitches, with frontal weft insertion, according to a net-type weave from three warp thread laps (10, 11, 12) separately distributed to the needles via three bars with guides operating such that: the front bar (BI) operates according to a pillar stitch weave; the central bar (BII) operates according to a weave producing transverse links (4); the rear bar (BIII) distributes its yarns (12) to each needle according to a weave picked under the needle; the yarns (10, 11, 12) used for producing said knitted fabric are synthetic monofilaments; the reflecting blades (1) are picked over the whole length of the knitted fabric.

### TECHNICAL FIELD

The present invention relates to a novel reflecting material, used in the agricultural field, developed in particular for the cultivation of vines using the technique called “solarization”. However, such a material can be used for any other plant or any type of cultivation when the beneficial effect of additional energy can prove to be advantageous for the producer.

The invention also relates to a process allowing such a reflecting material to be produced.

### PRIOR ART

In order to increase the amount and quality of solar radiation received by plants, especially vines, in order to prove the productivity and/or quality, it has been proposed, as is apparent from FR-A-2 733 665, to use a material which reflects solar radiation.

According to the teachings of this document, it is indicated that such a material must also have the following characteristics, taken individually or in combination:

tear strength;

permeability to air and water;

pliancy, allowing it to adhere well to the soil;

low oxidizability, and biodegradability so as not to be polluting;

good weatherability, allowing it to be reused several years in succession.

More specifically, it is indicated that such a material may be formed, for example, from a metallized film, from a lattice of reflecting fibers or of supports made of a synthetic or plant-based material, having a reflective coating, which is placed on the soil on each side of the base of the plants to be solarized, at a suitable distance, and covering an area of one square meter on each side of the plants, depending on the nature of the latter.

Although the proposals relating to the structure of the materials allowing the conditions mentioned in the above patent to be met can allow such conditions to be met, they involve, however, the development of specific products.

For example, the use of an aluminum film or of a reflecting film with a metallized appearance, or any other type of reflecting film, for example made of synthetic polymer, will have the drawback of lacking strength and adhesion to the soil and, moreover, must be adapted in order to be permeable to air and water and to adhere well to the soil.

Although combining such a film with a support consisting of a synthetic or natural material may allow the strength of the film and the adhesion to the soil to be improved, the problem then arises as to linking the two components of the complex and of adapting it in order to make it permeable to air and water.

Consequently, many proposals and trials have been made at the present time in order to obtain, simply and inexpensively, a material allowing all these conditions to be met.

Among these proposals, the most recent has been to propose to substitute for the metallized film that would be unreeled over the soil on either side of the plants a material which is in the form of a carpet composed of slats produced from an aluminum or other type of film, said slats having a width of two to three millimeters and being held in place within a network of yarns made of polyethylene or of another synthetic material.

Such a material makes it possible for at least 20% of the solar radiation striking the soil to be reflected onto the leaves and the bunches of grapes, improving the quality of the grapes and of the wine, and sometimes even the yield.

It has also been found that such “solarization or energization” helps the vine to resist parasites (especially the Botrytis fungus) and could modify the behavior of insect pests or disease propagators.

However, it has been found during trials that this type of carpet based on aluminum slats, held in place by a network of yarns, has a number of drawbacks, in that the aluminum can degrade over time, in that it is difficult to keep the strips mutually parallel and in that the strips can move and/or deform, and in that it is therefore difficult to control the reflecting power.

### SUMMARY OF THE INVENTION

An improvement to the aforementioned type of material has been found, and it is this which forms the subject matter of the present invention, consisting of a textile structure which ensures that the slats of aluminum film or of any other type of reflecting material are held juxtaposed side by side in the width direction and which makes it possible to completely fulfill the conditions allowing implementation of the process described in FR-2 733 665 in that it is completely stable and dimensionally blocked both lengthwise and widthwise, in that it has uniform air and water permeability over its entire area and above all in that it has completely defined solar radiation reflection properties and in that it does not degrade over time, especially by oxidation of the aluminum.

In general, the invention therefore relates to an improvement to the reflecting materials used in the field of cultivation in order to increase the amount and quality of the solar radiation received by plants, said covering consisting of a plane structure, of great length compared with its width, comprising reflecting slats juxtaposed side by side in the width direction and held together by a yarn network, and it is characterized in that

said network consists of a knitted fabric, made on a warp knitting machine with frontal weft insertion, in a net-type pattern from three plies of warp yarns distributed separately to the needles by means of three guide bars working in such a way that:

the front bar works in a chain stitch pattern;

the central bar works in a pattern making it possible to produce transverse links, in a predetermined sequence, between two wales of chain stitches, by means of long laps under several needles, the yarn overlapping one needle in a chain stitch pattern or simply being inserted over one needle during said sequence; and

the rear bar distributes its yarns to each needle in a one-needle underlapped pattern and with a tension such that, after the knitted fabric has been formed, said yarns are positioned so as to be straight in the length direction in the central part of the loops;

the yarns used in the construction of said knitted support fabric are synthetic monofilaments;

the reflecting slats are weft-inserted over the entire width of the knitted fabric and are held captive in each course of loops, forming, between two consecutive wales of chain stitches, a plurality of randomly oriented reflecting minifacets.

As material for making the reflecting slats, it is possible to use, in particular, an aluminum film that has received a protective surface coating or any other type of reflecting material, such as a film based on a metallized or nonmetallized synthetic polymer.

According to a preferred embodiment according to the invention, the reflecting slats are preferably colored. As type of coloration, although it may be envisioned using a green coloration, it has been found that a red coloration is more appropriate for further improving the results.

Moreover, the yarns used for constructing the network holding the reflecting slats in place are preferably synthetic yarns, and more particularly colored polyethylene yarns which have been treated in order to exhibit high resistance to the action of ultraviolet radiation and to have good weatherability.

The coloration both of the reflecting slats and of the yarns making up the network which holds said slats in place makes it possible to modify the overall reflectance spectra of the material, which is added to the spectra of the reflecting film or aluminum film which, as mentioned above, is also preferably colored.

By way of indication, a red coloration allows additional reflection which is added to the spectra of the aluminum film.

It has been found that, in the case of vines, the red coloration is more effective than any other coloration, for example green.

Of course, the invention is not limited to a red coloration and it would be conceivable to use different colorations, or even fluorescent or ultraviolet-generating colors.

By virtue of such a selection of means, admittedly known per se if they are taken separately, a reflecting structure is obtained which has, compared with the prior weft-knitted or braided structures, the following advantages:

the choice, as network allowing the reflecting strips to be held parallel to each other, of a net-type knitted structure makes it possible for it to be really strong not only in the longitudinal direction but also in the transverse direction due to the presence of the laps linking two successive wales of chain stitches;

the choice of a synthetic filament as the constituent of the structure of the holding network has the advantage of obtaining a sheet which, while still being able to be rolled up, is very “stiff” when it is laid out on the soil, the reverse face having, moreover, a relief effect which helps it to catch in said soil; in addition, the use of such a filament, and not of a multifilament yarn or spun yarn, makes it possible to control the covering area of the holding network compared with the total area of the reflecting strips, this covering area being, in the case of the right side of the material, between 5% and 15% and in the case of the reverse side between 10% and 30%, the percentage coverage being essentially due to the diameter of the yarns used;

moreover, although the material will in general be laid on the soil in such a way that it is in contact with the latter via its reverse side, it could be envisioned, when it is desired to reduce the solarization effect, to position it in such a way that reflection takes place off its reverse side;

insertion of the reflecting strips into each loop of the chain stitches also allows them, automatically and without any special precaution or modification, to be pinched at each loop, producing a multiplicity of reflecting minifacets improving the solarization of the plants;

air and water permeability is achieved automatically by the tiny space which exists between two consecutive slats;

finally, the coloration of the material of which the reflecting strips are made and/or of the yarns forming the loops of the holding network makes it possible, on the one hand, to act specifically on the physiological response of the plants and, on the other hand, possibly, from the esthetic standpoint, for the material to be better integrated into the cultivation environment.

Moreover, the material according to the invention has, on both its sides, reinforced regions, the knitting machine being threaded up so as to form two consecutive spaced-apart bands in which all the needles are fed with reinforcing yarn, the structure therefore at this point making it possible to easily adapt the means for securing the sheet to the soil.

To produce such a material, the knitting process, which is in itself a known process, is adapted so that the reflecting strips are inserted during the knitting operation by keeping them under tension and held flat during presentation to the set of needles in order to incorporate them into a course of the knitted fabric being formed, the width of said strips being slightly greater than the length of the loops produced on the knitting machine, allowing a stress to be produced thereat, pinching them laterally during formation of the loops and resulting in the automatic production of reflecting minifacets at the surface of the visible regions located between two consecutive chain stitches and the immobilization of said strips.

During its use, the material can be positioned on the soil in such a way that its reverse side comprising the multi-needle underlaps and the reverse side of the wales of chain stitches which form a relief are positioned facing the soil, thereby improving the stability on the latter, limiting slippage and the formation of wrinkles.

The yarns used in the construction of the knitted net holding the reflecting strips in place will preferably be colored synthetic filaments, especially polyethylene filaments, the linear density of which will advantageously be between 300 dtex and 600 dtex, a linear density of less than 300 dtex resulting in too pliant a structure, lacking strength, and a linear density greater than 600 dtex resulting in too stiff a structure and reducing the reflecting area of the strips.

However, it could be envisioned, for specific applications, to use finer or coarser yarns than the aforementioned range, especially when it is desired to vary the ratio of the area occupied by said yarns to the area of the reflecting strips.

Preferably, the reflecting strips will be made from a film of pure aluminum, having a protective surface coating consisting, for example, of a transparent or preferably colored film applied to each side, or even only on one side.

However, it could be envisioned to use any other type of reflecting material without departing from the scope of the invention.

In general, these strips will have a width of between one and five millimeters, preferably between two and three millimeters.

The knitted net according to the invention will comprise, in the longitudinal direction, parallel chain stitches which cover, on the one hand, the straight yarn incorporated during knitting and which does not loop and, on the other hand, the yarn which allows the formation of the transverse links and which may or may not loop into the chain stitches.

The space between two consecutive chain stitches may be modified on the knitting machine according to the way in which it has been threaded up and, in general, this space is between 0.5 and 1.5 cm and more particularly about one centimeter.

The width of the transverse strips inserted into the loops will preferably be slightly greater than the length of said loops so as to produce the stress thereat allowing reflecting minifacets to be produced on the product and allowing the transverse strips to be completely immobilized, these being unable to slide within said loops.

The invention and the advantages that it affords will, however, be more clearly understood by means of the illustrative example given below by way of indication, but implying no limitation and which is illustrated by the appended drawings.

### BRIEF DESCRIPTION OF THE DRAWINGS

The appended drawings illustrate one embodiment

a material according to the invention;

FIG. 1 being a schematic perspective representation of a material according to the invention;

FIG. 2 being a conventional graphical representation of a pattern of knitted fabric ensuring that the reflecting strips are held in place;

FIG. 3 schematically illustrating the position of the straight yarn incorporated into the chain stitches;

FIG. 4 being a reproduction of a material produced according to the invention, showing more particularly the central region of said material and the reinforced selvages that it has; and

FIG. 5 being a schematic view illustrating the reflection of the solar radiation off the surface of a material according to the invention.

### MANNER OF REALIZING THE INVENTION

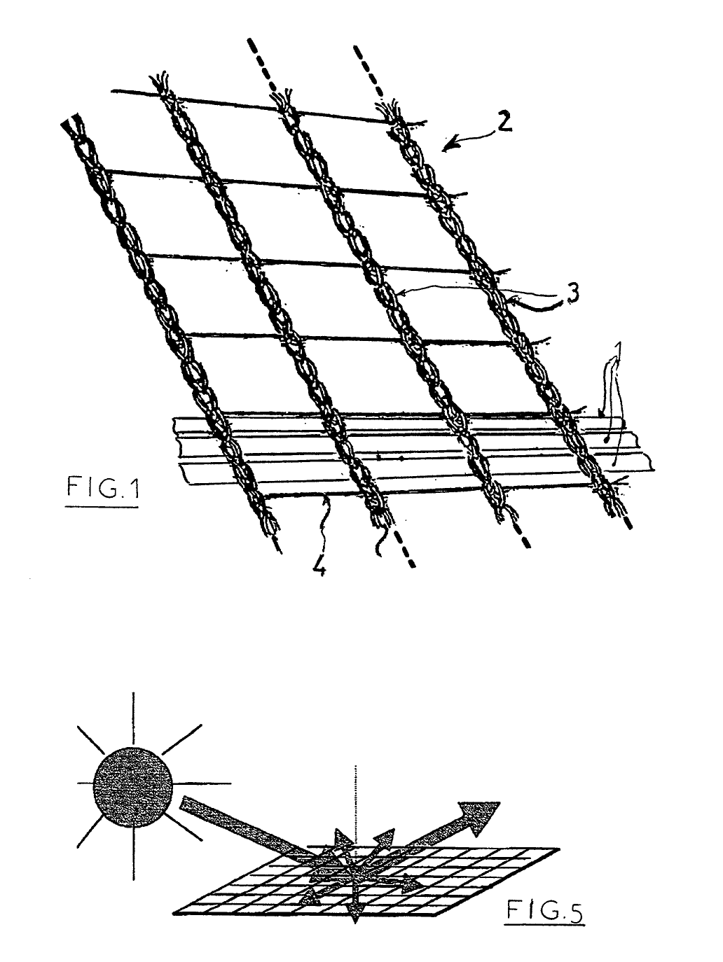

Referring more particularly to the appended FIGS. 1 to 3, the material according to the invention therefore consists of a plane structure, of great length compared with its width, comprising reflecting slats (1) juxtaposed side by side in the width direction and held together by a network of yarns, said network being denoted by the general reference (2), only three slats being shown in FIG. 1.

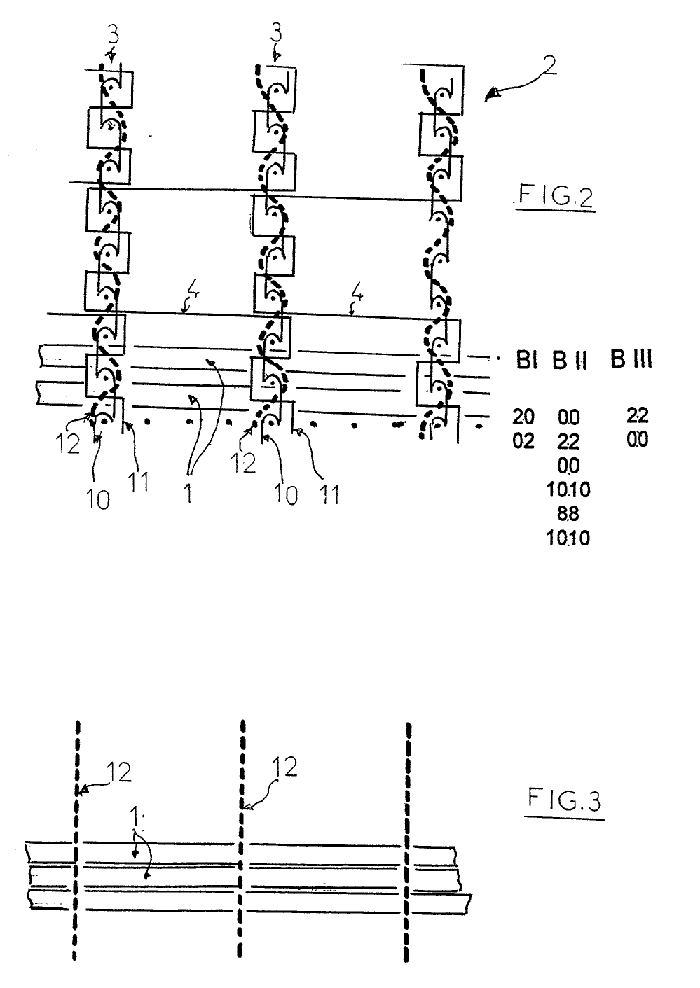

According to the invention, the network (2) of yarns, the overall structure of which is shown in FIGS. 2, 3 and 4, consists of a knitted fabric produced on a warp knitting machine with frontal weft insertion, and in a net pattern, that is to say a pattern which makes it possible to obtain a structure consisting of spaced-apart wales (3) of chain stitches and linked together, at regular intervals, by transverse yarns (4).

The spacing between two wales (3) of loops will be determined according to the mechanical properties, especially the tensile strength, that it is desired to give the material, and also so as to affect the reflectivity of the aluminum strips as little as possible, the right side of the product being more reflecting than the reverse side, which has underlaps under one or more needles allowing the formation of transverse links.

To produce such a structure, a knitting machine is used which has at least three guide bars for distributing the yarns to the knitting needles which are fed with yarn in a predetermined sequence according to the spacing that it is desired to have between two wales (3) of loops.

The spacing between two wales (3) of loops is obtained by degaging the knitting machine, that is to say removing a certain number of needles, for example two in three or three in four, the bars for distributing the warp yarns being threaded up so that there are voids between two guide bars fed with yarn, for example fed every two, three or four guide bars if the knitting machine is degaged two, three or four times.

Referring to FIG. 2, the front bar (BI) of the knitting machine which distributes the yarn (10) works in a 0.2/2.0 chain stitch pattern.

The central bar (BII) is fed with yarn (11) intended to form the transverse links. This bar distributes the yarn (11) in a predetermined sequence, in which it forms loops or simple one-needle overlaps in a 2.0/0.2 or 0.0/2.2 pattern over a predetermined number of courses, in order to produce a similar sequence, but in a manner offset by one long underlap (4), on a wale of parallel loops. This structure therefore makes it possible not only to give the article produced transverse strength but also good tear strength.

To improve the strength in the length direction and above all to control the pinching of the reflecting slats making it possible, after production, to obtain a plurality of randomly oriented minifacets, a third yarn (12) is incorporated into each wale of chain stitches by means of the rear bar (BIII), said third yarn (12) being represented by the dotted lines and working in the 0.0/2.2 pattern, that is to say it does not form loops, and is simply held captive within the chain stitch loops and positioned so as to be straight after the knitted fabric has been formed (FIG. 3).

Each reflecting strip (1) is inserted into each course of loops of the knitted fabric by means of a presentation assembly bringing it flat, under tension, against all the warp yarns, after the knocking-over phase.

Consequently, said strips are inserted into each course of loops and held in place perfectly by the latter. By adjusting the length of the loops, the strip may be pinched to a greater or lesser extent, which pinching not only ensures that the strip is perfectly held in place but also forms on its surface a plurality of reflecting minifacets which are randomly oriented.

In the regions of the knitted fabric which have multi-needle underlaps, the strips cover the underlap of the yarn (11) which extends transversely and links two or more consecutive wales (3).

A structure is therefore obtained whose right side comprises a plurality of reflecting strips (1) held in place within the loops of the wales (3) which consist of chain stitch yarns (10) combined with a longitudinal yarn (12) kept approximately straight within said wale of chain stitches.

The transverse links which consist of the multi-needle underlaps (4) of the central bar distributing the yarn (11) are positioned on the reverse side of the structure, said yarn (11) possibly being simply inserted or possibly meshed with each chain stitch.

### EXAMPLE

An article according to the invention was produced on a warp knitting machine with front weft insertion from the company KARL MAYER having an initial gage of 12 (that is to say 12 needles per inch or 25.4 mm).

To produce the article according to the invention, this knitting machine was degaged so as to keep only one needle in four.

The guide bars of this knitting machine were fed with a monofilament yarn 0.28 mm in diameter (600 dtex) made of polyethylene colored red or green—red being more particularly suitable in the case of growing vines—and in an arrangement such as that shown in FIG. 2, that is to say with one full space for four empty spaces.

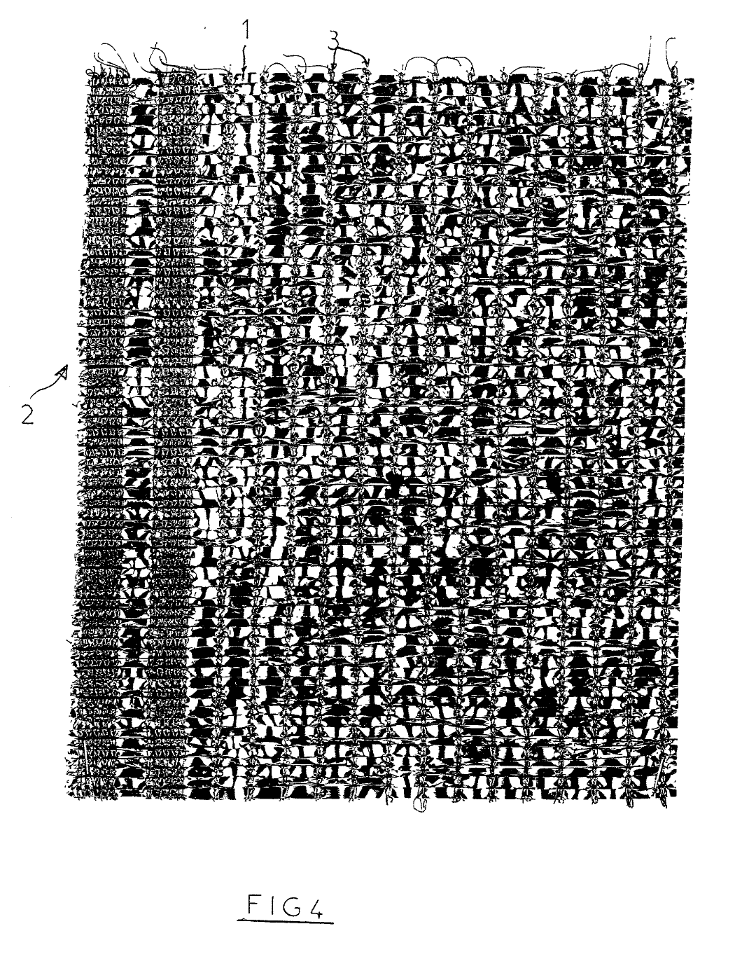

Along the lateral parts of the knitted fabric (see FIG. 4), the guide bars were threaded up so as to form two bands of full tricot, the twelve lateral guide bars being threaded up as four full spaces, four empty spaces, four full spaces, four knitting needles being removed between the two regions where the tricot is produced. This region thus reinforced serves to mechanically secure the material to the soil.

The knitting pattern is as follows.

The front bar (BI) works in a 0.2/2.0 chain stitch pattern.

The central bar (BII) makes it possible to produce the transverse links (4) and therefore comprises a sequence, in the present case over four courses, of a 0.0/2.2 one-needle overlapped pattern followed by a sequence obtained by a long underlap, for example 10.10/12.12, which allows the transverse links (4) to be formed.

Possibly, the yarns (11) of this bar could mesh with the chain stitch yarns (10).

The rear bar (BIII) is used to distribute a third yarn (12) in a 0.0/2.2 pattern, that is to say it does not form loops and is simply gripped into the chain stitch yarns (11).

Inserted into each course of loops are reflecting strips (1), having a width of 3 mm, which are obtained from a film of aluminum having a protective coating which does not affect the reflectivity of said aluminum film.

The knitting machine is set so that a loop has a length of 2 mm.

By knitting in this way, the strips are therefore slightly pinched at the point where they are trapped within the loop, resulting in the formation of a multiplicity of reflecting minifacets on the surface of the product obtained by this deformation.

Dropping from the knitting machine is a product in which the strips (1) are held side by side within the wales of loops consisting of the yarn chain stitches spaced apart by a distance of 0.8 cm, the, transverse links (4) obtained by the laps also being a distance of 0.8 cm apart.

Such a product is practically nondeformable both lengthwise and widthwise and is particularly suitable for being used in the various fields of agriculture or the cultivation of plants—especially vegetables, fruit trees, vines etc.—in order to increase the amount of solar radiation received by the plants and to modify the composition thereof.

Moreover, such a material is easy to lay and secure to the soil because of its reinforced selvages, is lightweight (in the above example, it weighs 160 g/m²), is permeable to rain since, even if the strips are held side by side, a small space exists between two consecutive strips because of the use of a knitted structure for holding them in place. However, this material is sufficiently dense to prevent the growth of weeds and thus to limit chemical weedkilling treatment.

Finally, as is apparent from FIG. 5, compared with a plane reflecting surface such as a film, the fact that the material according to the invention has on the surface a multiplicity of randomly oriented facets, this makes it possible to obtain many multidirectional specular reflections allowing the incident light to be better dispersed, which effect improves its action on plants and makes it possible to have greater illumination on the lower parts of plants, despite the variation in angles of incidence of said light between 0 and 180° according to the path of the sun over the course of the day.

1. A reflecting material that can be used in the field of cultivation in order to increase the amount of solar radiation received by plants or to modify the quality of the solar radiation, said covering consisting of a plane structure, of great length compared with its width, comprising reflecting slats (1) juxtaposed side by side in the width direction and held together by a yarn network (2), characterized in that:
said network (2) consists of a knitted fabric, made on a warp knitting machine with frontal weft insertion, in a net-type pattern from three plies of warp yarns (10, 11, 12) distributed separately to the needles by means of three guide bars (BI, BII, BIII) working in such a way that:
the yarns (10) of the front bar (BI) form parallel spaced-apart wales of chain stitches;
the yarns (11) of the central bar (BII) form transverse links (4) in a predetermined sequence between two wales (3) of chain stitches, each yarn (11) meshing in a chain stitch pattern or simply being weft-inserted during said sequence; and
the yarns (12) of the rear bar (BIII) are distributed in a weft pattern and are positioned in a straight manner in the longitudinal direction in the central part of the loops;
the yarns (10, 11, 12) used in the construction of said knitted support fabric are synthetic monofilaments;
the reflecting slats (1) are weft-inserted over the entire width of the knitted fabric and are held captive in each course of loops, forming, between two consecutive wales of chain stitches, a plurality of randomly oriented reflecting minifacets.

2. The material as claimed in claim 1, characterized in that the reflecting slats (1) and/or the yarns constituting the linking network (2) are colored.

3. The material as claimed in claim 2, characterized in that the coloring is red.

4. The material as claimed in one of claims 1 to 3, characterized in that the reflecting slats (1) are based on an aluminum film having a colored or colorless protective surface coating.

5. The material as claimed in one of claims 1 to 4, characterized in that the yarns (10, 11, 12) constituting the network for linking the reflecting slats are colored or colorless polyethylene filaments.

6. The material as claimed in one of claims 1 to 5, characterized in that it has, on both its sides, reinforced regions, the knitting machine being threaded up so as to form two consecutive spaced-apart bands in which all the needles are fed with reinforcing yarn, the structure therefore at this point making it possible to easily adapt the means for securing the sheet to the soil.

7. A process for producing a reflecting material as claimed in one of claims 1 to 6, characterized in that the reflecting strips (1) are inserted during the knitting operation by keeping them under tension and held flat during presentation to the set of needles in order to incorporate them into a course of knitted fabric being formed, the width of said strips being slightly greater than the length of the loops produced on the knitting machine allowing a stress to be produced thereat, pinching them laterally during formation of the loops and resulting in the formation of reflecting minifacets at the surface of the visible regions located between two consecutive chain stitches and the immobilization of said strips.

8. The use of a material as claimed in one of claims 1 to 6, characterized in that it is positioned on the soil in such a way that its comprising the multi-needle underlaps and the reverse side of the wales of chain stitches which form a relief are positioned facing the soil, thereby improving the stability on the latter, limiting slippage and the formation of wrinkles.
